(19) United States
(12) Patent Application Publication
(10) Pub. No.: US 2026/0051935 A1
(43) Pub. Date: Feb. 19, 2026

(54) ENCODING AND DECODING SPATIAL DOMAIN BASIS SELECTION FOR MULTIPLE TRANSMISSION RECEPTION POINT COMMUNICATION

(71) Applicant: QUALCOMM Incorporated, San Diego, CA (US)

(72) Inventors: Chao WEI, Beijing (CN); Jing DAI, Beijing (CN); Min HUANG, Beijing (CN)

(21) Appl. No.: 19/102,712

(22) PCT Filed: Oct. 8, 2022
(86) PCT No.: PCT/CN2022/123761

§ 371 Date: Feb. 10, 2025

(51) Int. Cl. H04B 7/06; H04W 72/044

(52) U.S. Cl. CPC H04B 7/0626; H04W 72/046

(57) ABSTRACT

Various aspects of the present disclosure generally relate to wireless communication. In some aspects, a user equipment (UE) may group a total quantity of spatial domain (SD) bases associated with multiple transmission reception points (TRPs) into one or more SD basis groups. The UE may select, for each respective SD basis group, one or more SD bases from the respective set of SD bases. The UE may identify, for each respective SD basis group, an index that represents the one or more SD bases selected for the respective SD basis group. The UE may transmit, to a network node, channel state information (CSI) that includes a joint SD basis selection indicator for the multiple TRPs, the joint SD basis selection indicator indicating, for each respective SD basis group, the respective index representing the one or more SD bases selected for the respective SD basis group. Numerous other aspects are provided.

### FIELD OF THE DISCLOSURE

Aspects of the present disclosure generally relate to wireless communication and specifically, to techniques and apparatuses for encoding and decoding a spatial domain (SD) basis selection for multiple transmission reception point (mTRP) communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In a multiple transmission reception point (mTRP) configuration, coherent joint transmission (CJT) may be enabled to improve coverage and improve average throughput with a high performance backhaul and synchronization among transmission reception points (TRPs) that may be disposed at different locations. For example, in a CJT configuration, multiple TRPs may have access to detailed channel state information (CSI) related to respective serving links from the TRPs to a served UE. Based on the detailed CSI shared among cooperating or coordinated TRPs, each TRP associated with the CJT configuration jointly transmits the same message to a target UE on the same time and frequency resources, and the signals transmitted from different TRPs are jointly precoded with a prior phase alignment and close synchronization across TRPs such that the signals transmitted from different TRPs coherently combine at the target UE (for example, by exploiting phase and potential amplitude relations between channels associated with different TRPs). Accordingly, to enable CJT in an mTRP configuration, a UE generally transmits CSI to a network node that includes or controls the multiple TRPs such that a suitable precoder can be configured at each respective TRP. For example, the CSI transmitted to the network node includes a spatial domain (SD) basis selection per TRP or TRP group, where the SD basis selection includes a beam indication parameter that is encoded to represent a selection of one or more beams or SD bases out of a total quantity of beams or SD bases associated with each TRP or TRP group using a combination coefficients table. However, using a separate SD basis selection per TRP or TRP group may significantly increase overhead of the CSI that is transmitted to the network node, because the CSI has to carry an SD basis selection indicator for each TRP or TRP group.

### SUMMARY

Some aspects described herein relate to a user equipment (UE) for wireless communication. The UE may include at least one processor and at least one memory, communicatively coupled with the at least one processor, that stores processor-readable code. The processor-readable code, when executed by the at least one processor, may be configured to cause the UE to group a total quantity of spatial domain (SD) bases associated with multiple transmission reception points (TRPs) into one or more SD basis groups, each SD basis group including a set of SD bases. The processor-readable code, when executed by the at least one processor, may be configured to cause the UE to select, for each respective SD basis group of the one or more SD basis groups, one or more SD bases from the respective set of SD bases included in the respective SD basis group. The processor-readable code, when executed by the at least one processor, may be configured to cause the UE to identify, for each respective SD basis group of the one or more SD basis groups, an index that represents the one or more SD bases selected for the respective SD basis group. The processor-readable code, when executed by the at least one processor, may be configured to cause the UE to transmit, to a network node, channel state information (CSI) that includes a joint SD basis selection indicator for the multiple TRPs, the joint SD basis selection indicator indicating, for each respective SD basis group of the one or more SD basis groups, the respective index representing the one or more SD bases selected for the respective SD basis group.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to receive, from a UE, CSI that includes a joint SD basis selection indicator for multiple TRPs. The processor-readable code, when executed by the at least one processor, may be configured to cause the network node to decode, for each of one or more SD basis groups, a respective index that represents one or more SD bases selected for the respective SD basis group based at least in part on the joint SD basis selection indicator. The processor-readable code, when executed by the at least one processor, may be configured to cause the network node to decode, for each of the one or more SD basis groups, one or more SD basis indexes based at least in part on the respective index that represents the one or more SD bases selected for the respective SD basis group and an associated TRP index.

Some aspects described herein relate to a method of wireless communication performed by a UE. The method may include grouping a total quantity of SD bases associated with multiple TRPs into one or more SD basis groups, each SD basis group including a set of SD bases. The method may include selecting, for each respective SD basis group of the one or more SD basis groups, one or more SD bases from the respective set of SD bases included in the respective SD basis group. The method may include identifying, for each respective SD basis group of the one or more SD basis groups, an index that represents the one or more SD bases selected for the respective SD basis group. The method may include transmitting, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group.

Some aspects described herein relate to a method of wireless communication performed by a network node. The method may include receiving, from a UE, CSI that includes a joint SD basis selection indicator for multiple TRPs. The method may include decoding, for each of one or more SD basis groups, a respective index that represents one or more SD bases selected for the respective SD basis group based at least in part on the joint SD basis selection indicator. The method may include decoding, for each of the one or more SD basis groups, one or more SD basis indexes based at least in part on the respective index that represents the one or more SD bases selected for the respective SD basis group and an associated TRP index.

Some aspects described herein relate to a non-transitory computer-readable medium that stores a set of instructions for wireless communication by a UE. The set of instructions, when executed by one or more processors of the UE, may cause the UE to group a total quantity of SD bases associated with multiple TRPs into one or more SD basis groups, each SD basis group including a set of SD bases. The set of instructions, when executed by one or more processors of the UE, may cause the UE to select, for each respective SD basis group of the one or more SD basis groups, one or more SD bases from the respective set of SD bases included in the respective SD basis group. The set of instructions, when executed by one or more processors of the UE, may cause the UE to identify, for each respective SD basis group of the one or more SD basis groups, an index that represents the one or more SD bases selected for the respective SD basis group. The set of instructions, when executed by one or more processors of the UE, may cause the UE to transmit, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group.

Some aspects described herein relate to a non-transitory computer-readable medium that stores a set of instructions for wireless communication by a network node. The set of instructions, when executed by one or more processors of the network node, may cause the network node to receive, from a UE, CSI that includes a joint SD basis selection indicator for multiple TRPs. The set of instructions, when executed by one or more processors of the network node, may cause the network node to decode, for each of one or more SD basis groups, a respective index that represents one or more SD bases selected for the respective SD basis group based at least in part on the joint SD basis selection indicator. The set of instructions, when executed by one or more processors of the network node, may cause the network node to decode, for each of the one or more SD basis groups, one or more SD basis indexes based at least in part on the respective index that represents the one or more SD bases selected for the respective SD basis group and an associated TRP index.

Some aspects described herein relate to an apparatus for wireless communication. The apparatus may include means for grouping a total quantity of SD bases associated with multiple TRPs into one or more SD basis groups, each SD basis group including a set of SD bases. The apparatus may include means for selecting, for each respective SD basis group of the one or more SD basis groups, one or more SD bases from the respective set of SD bases included in the respective SD basis group. The apparatus may include means for identifying, for each respective SD basis group of the one or more SD basis groups, an index that represents the one or more SD bases selected for the respective SD basis group. The apparatus may include means for transmitting, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group.

Some aspects described herein relate to an apparatus for wireless communication. The apparatus may include means for receiving, from a UE, CSI that includes a joint SD basis selection indicator for multiple TRPs. The apparatus may include means for decoding, for each of one or more SD basis groups, a respective index that represents one or more SD bases selected for the respective SD basis group based at least in part on the joint SD basis selection indicator. The apparatus may include means for decoding, for each of the one or more SD basis groups, one or more SD basis indexes based at least in part on the respective index that represents the one or more SD bases selected for the respective SD basis group and an associated TRP index.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating examples of coherent joint transmission (CJT) precoding for multiple transmission reception point (mTRP) communication in accordance with the present disclosure.

FIG. 5 is a diagram illustrating an example of CJT in an mTRP configuration in accordance with the present disclosure.

FIG. 6 is a diagram illustrating an example of channel state information (CSI) associated with non-CJT in an mTRP configuration in accordance with the present disclosure.

FIGS. 7A-7B are diagrams illustrating an example of encoding and decoding a spatial domain (SD) basis selection indicator that may be included in CSI to enable CJT in an mTRP configuration in accordance with the present disclosure.

FIG. 8 is a diagram illustrating an example of an SD basis selection indicator for CJT in an mTRP configuration in accordance with the present disclosure.

FIGS. 9A-9D are diagrams illustrating examples associated with encoding and decoding an SD basis selection for mTRP communication in accordance with the present disclosure.

FIG. 10 is a flowchart illustrating an example process performed, for example, by a UE in accordance with the present disclosure.

FIG. 11 is a flowchart illustrating an example process performed, for example, by a network node in accordance with the present disclosure.

FIGS. 12-13 are diagrams of example apparatuses for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to encoding and decoding a joint spatial domain (SD) basis selection to enable coherent joint transmission (CJT) in a multiple transmission point (mTRP) configuration. Some aspects more specifically relate to a joint SD basis selection indicator that uses a combination coefficients table for reporting an SD basis selection per transmission reception point (TRP) or TRP group. For example, in some aspects, a user equipment (UE) may divide a total quantity of SD bases associated with multiple TRPs into one or more SD basis groups, and the UE may select a quantity of SD bases out of the total quantity of SD bases in each SD basis group. In some aspects, the UE may then calculate, for each SD basis group, an index that represents the selected SD bases in each SD basis group using the combination coefficients table for reporting SD basis selections per TRP or TRP group. In some aspects, the UE may then encode the joint SD basis selection across the multiple TRPs based on the index(es) that represent the selected SD bases in each respective SD basis group (for example, using a scaling factor or a vector representation). Accordingly, the UE may transmit channel state information (CSI) that includes the joint SD basis selection to a network node that includes or controls the multiple TRPs, and the network node may decode the joint SD basis selection to derive a precoder to be applied at each TRP. For example, in some aspects, the network node may determine the quantity of SD basis groups based on the quantity of TRPs involved in the CJT configuration, the total quantity of SD bases per TRP, and the quantity of TRPs in each SD basis group, which the network node may use to determine the index(es) that represent the selected SD bases in each respective SD basis group from the joint SD basis selection included in the CSI. For each SD basis group, the network node may use the same decoding algorithm used to decode an SD basis selection associated with a specific TRP or TRP group to identify one or more SD basis indexes based on the index associated with the SD basis group and an associated TRP index.

Particular aspects of the subject matter described in this disclosure can be implemented to realize one or more of the following potential advantages. In some examples, the described techniques can be used to provide a joint SD basis selection across multiple TRPs, which may reduce the overhead associated with CSI that is transmitted from a UE to a network node to enable CJT in an mTRP configuration. Furthermore, in some examples, the described techniques can be used to encode and decode the joint SD basis selection using a combination coefficients table associated with reporting an SD basis selection per TRP or TRP group, which may minimize a complexity increase associated with encoding and decoding the joint SD basis selection. For example, extending the combination coefficients table to include additional entries to represent all possible permutations of SD basis selections across multiple (for example, up to four) TRPs would significantly increase memory requirements associated with storing the larger combination coefficients table and significantly increase encoding and decoding complexity at both the UE and the network node due to the larger combination coefficients table including entries with very large values. Furthermore, the very large values included in an extended combination coefficients table would require a large quantity of bits to represent the value, which can add to the CSI overhead. Accordingly, in some examples, the described techniques can be used to minimize increases in complexity, memory requirements, and/or CSI overhead by encoding and decoding the joint SD basis selection using the combination coefficients table associated with reporting an SD basis selection per TRP or TRP group.

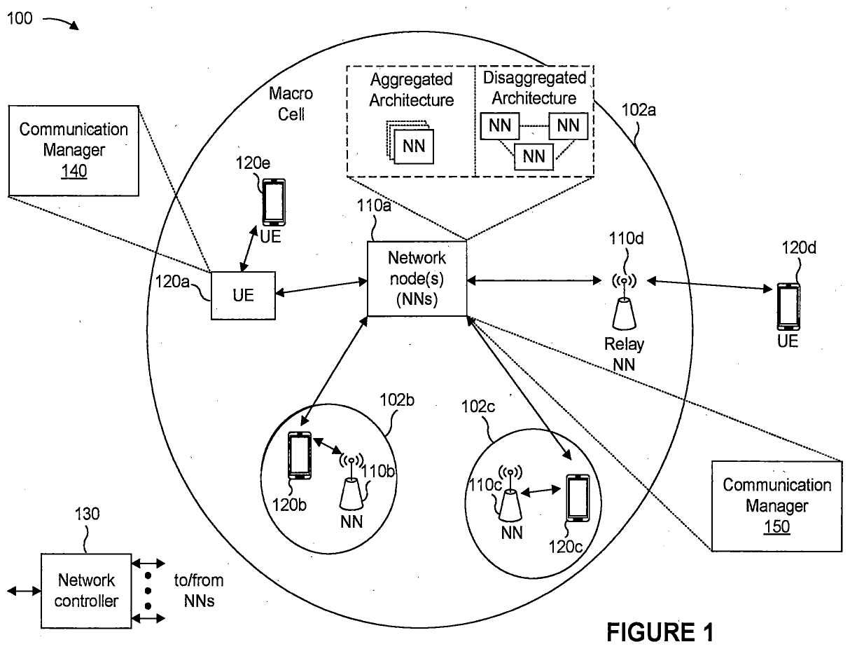

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a TRP, a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHz), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may group a total quantity of SD bases associated with multiple TRPs into one or more SD basis groups, each SD basis group including a set of SD bases; select, for each respective SD basis group of the one or more SD basis groups, one or more SD bases from the respective set of SD bases included in the respective SD basis group; identify, for each respective SD basis group of the one or more SD basis groups, an index that represents the one or more SD bases selected for the respective SD basis group; and transmit, to a network node 110, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group. Additionally or alternatively, the communication manager 140 may perform one or more other operations described herein.

In some aspects, the network node 110 may include a communication manager 150. As described in more detail elsewhere herein, the communication manager 150 may receive, from a UE 120, CSI that includes a joint SD basis selection indicator for multiple TRPs; decode, for each of one or more SD basis groups, a respective index that represents one or more SD bases selected for the respective SD basis group based at least in part on the joint SD basis selection indicator; and decode, for each of the one or more SD basis groups, one or more SD basis indexes based at least in part on the respective index that represents the one or more SD bases selected for the respective SD basis group and an associated TRP index. Additionally or alternatively, the communication manager 150 may perform one or more other operations described herein.

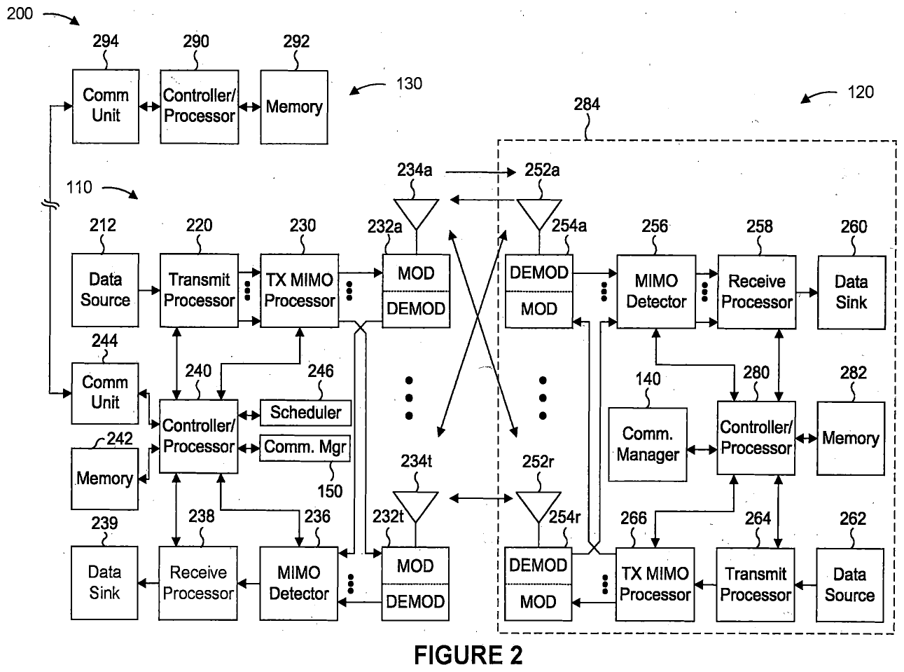

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

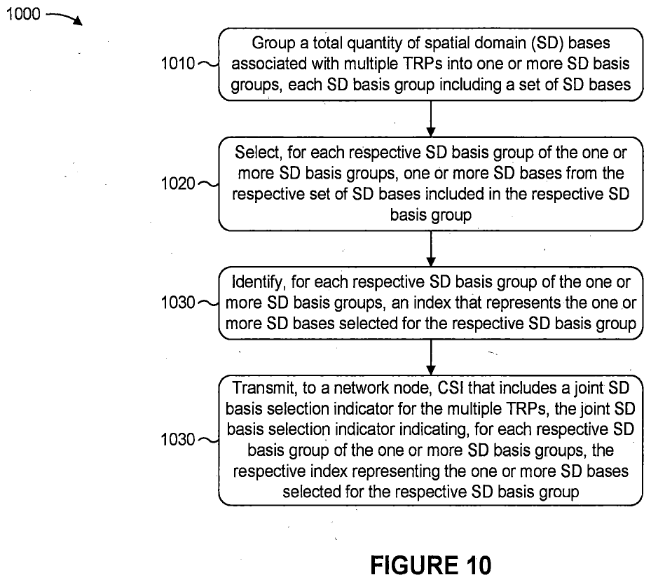

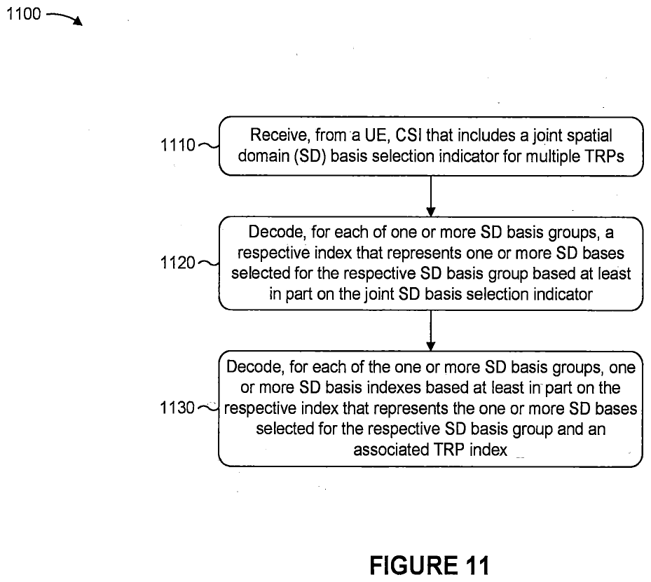

The controller/processor 240 of the network node 110, the controller/processor 280 of the UE 120, or any other component(s) of FIG. 2 may perform one or more techniques associated with encoding and decoding an SD basis selection for multiple transmission reception point (mTRP) communication, as described in more detail elsewhere herein. For example, the controller/processor 240 of the network node 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, the UE 120 includes means for grouping a total quantity of SD bases associated with multiple TRPs into one or more SD basis groups, each SD basis group including a set of SD bases; means for selecting, for each respective SD basis group of the one or more SD basis groups, one or more SD bases from the respective set of SD bases included in the respective SD basis group; means for identifying, for each respective SD basis group of the one or more SD basis groups, an index that represents the one or more SD bases selected for the respective SD basis group; and/or means for transmitting, to a network node 110, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE 120, CSI that includes a joint SD basis selection indicator for multiple TRPs; means for decoding, for each of one or more SD basis groups, a respective index that represents one or more SD bases selected for the respective SD basis group based at least in part on the joint SD basis selection indicator; and/or means for decoding, for each of the one or more SD basis groups, one or more SD basis indexes based at least in part on the respective index that represents the one or more SD bases selected for the respective SD basis group and an associated TRP index. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, the DU, and the RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

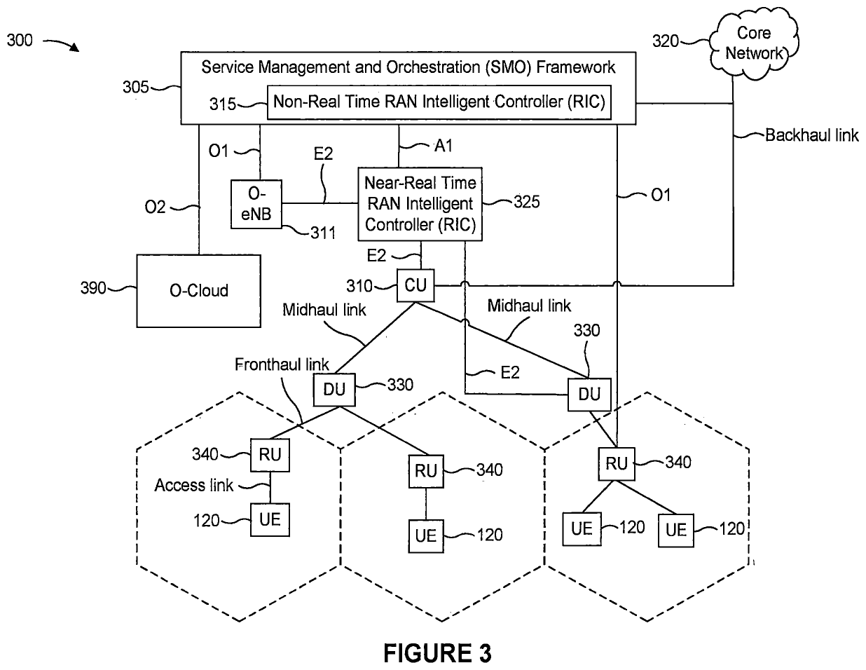

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

In an mTRP configuration, CJT may be enabled to improve coverage and improve average throughput with a high performance backhaul and synchronization among TRPs that may be disposed at different locations. For example, in a CJT configuration, multiple TRPs may have access to detailed CSI related to respective serving links from the TRPs to a served UE. Based on the detailed CSI shared among cooperating or coordinated TRPs, each TRP associated with the CJT configuration jointly transmits the same message to a target UE on the same time and frequency resources, and the signals transmitted from different TRPs are jointly precoded with a prior phase alignment and close synchronization across TRPs such that the signals transmitted from different TRPs coherently combine at the target UE (for example, by exploiting phase and potential amplitude relations between channels associated with different TRPs). Accordingly, to enable CJT in an mTRP configuration, a UE generally transmits CSI to a network node that includes or controls the multiple TRPs such that a suitable precoder can be configured at each respective TRP. For example, the CSI transmitted to the network node includes an SD basis selection per TRP or TRP group, where the SD basis selection includes a beam indication parameter that is encoded to represent a selection of one or more beams out of a total quantity of beams associated with each TRP or TRP group using a combination coefficients table. However, using a separate SD basis selection per TRP or TRP group may significantly increase overhead of the CSI that is transmitted to the network node, because the CSI has to carry an SD basis selection indicator for each TRP or TRP group.

Various aspects relate generally to encoding and decoding a joint SD basis selection to enable CJT in an mTRP configuration. Some aspects more specifically relate to a joint SD basis selection indicator that uses a combination coefficients table for reporting an SD basis selection per TRP or TRP group. For example, in some aspects, a UE may divide a total quantity of SD bases associated with multiple TRPs into one or more SD basis groups, and the UE may select a quantity of SD bases out of the total quantity of SD bases in each SD basis group. In some aspects, the UE may then calculate, for each SD basis group, an index that represents the selected SD bases in each SD basis group using the combination coefficients table for reporting SD basis selections per TRP or TRP group. In some aspects, the UE may then encode the joint SD basis selection across the multiple TRPs based on the index(es) that represent the selected SD bases in each respective SD basis group (for example, using a scaling factor or a vector representation). Accordingly, the UE may transmit CSI that includes the joint SD basis selection to a network node that includes or controls the multiple TRPs, and the network node may decode the joint SD basis selection to derive a precoder to be applied at each TRP. For example, in some aspects, the network node may determine the quantity of SD basis groups based on the quantity of TRPs involved in the CJT configuration, the total quantity of SD bases per TRP, and the quantity of TRPs in each SD basis group, which the network node may use to determine the index(es) that represent the selected SD bases in each respective SD basis group from the joint SD basis selection included in the CSI. For each SD basis group, the network node may use the same decoding algorithm used to decode an SD basis selection associated with a specific TRP or TRP group to identify one or more SD basis indexes based on the index associated with the SD basis group and an associated TRP index.

Particular aspects of the subject matter described in this disclosure can be implemented to realize one or more of the following potential advantages. In some examples, the described techniques can be used to provide a joint SD basis selection across multiple TRPs, which may reduce the overhead associated with CSI that is transmitted from a UE to a network node to enable CJT in an mTRP configuration. Furthermore, in some examples, the described techniques can be used to encode and decode the joint SD basis selection using a combination coefficients table associated with reporting an SD basis selection per TRP or TRP group, which may minimize a complexity increase associated with encoding and decoding the joint SD basis selection. For example, extending the combination coefficients table to include additional entries to represent all possible permutations of SD basis selections across multiple (for example, up to four) TRPs would significantly increase memory requirements associated with storing the larger combination coefficients table and significantly increase encoding and decoding complexity at both the UE and the network node due to the larger combination coefficients table including entries with very large values. Furthermore, the very large values included in an extended combination coefficients table would require a large number of bits to represent the value, which can add to the CSI overhead. Accordingly, in some examples, the described techniques can be used to minimize increases in complexity, memory requirements, and/or CSI overhead by encoding and decoding the joint SD basis selection using the combination coefficients table associated with reporting an SD basis selection per TRP or TRP group.

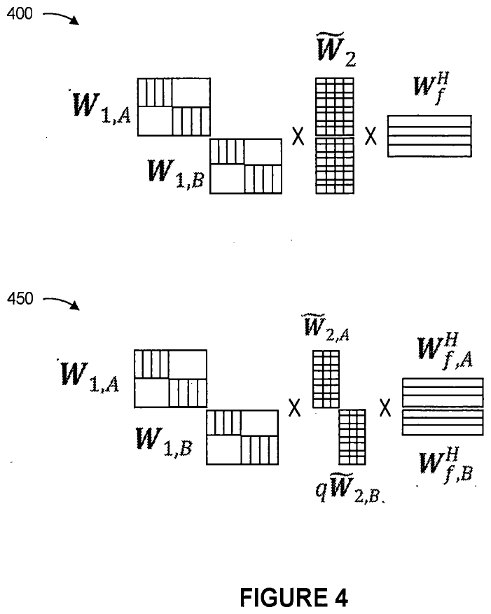

FIG. 4 is a diagram illustrating examples 400, 450 of CJT precoding for mTRP communication in accordance with the present disclosure. More particularly, in FIG. 4, example 400 depicts a joint frequency domain CJT precoding, and example 450 depicts a separate frequency domain CJT precoding.

For example, referring to FIG. 4, example 400 depicts a joint frequency domain CJT precoding that uses a precoder associated with one or more TRPs of a network node, represented by W. In some cases, the precoder may be composed from an SD basis matrix for each TRP (for example, represented by W_{1,A} and W_{1,B} in example 400, although other examples may use joint SD bases represented by W₁), a frequency domain (FD) basis matrix (for example, represented by

$${W}_{f}^{H}$$

in example 400), and a coefficient matrix (for example, represented by \tilde{W}₂ in example 400). The coefficient matrix is a normal matrix and thus represents a joint codebook for the TRPs. The TRPs perform CJT using one layer in example 400. Other examples may use additional layers (for example, two, three, four, or more layers).

Alternatively, still referring to FIG. 4, example 450 depicts a separate frequency domain CJT precoding that uses a precoder associated with one or more TRPs of a network node, represented by W. In some cases, the precoder may be composed from an SD basis matrix for each TRP (for example, represented by W_{1,A} and W_{1,B} in example 450, although other examples may use joint SD bases represented by W₁), an FD basis matrix for each TRP (for example, represented by

$${W}_{f , A}^{H} and {W}_{f , B}^{H}$$

in example 450), and a coefficient matrix (for example, represented by a first portion \tilde{W}_{2,A} associated with a first TRP and a second portion q\tilde{W}_{2,B} associated with a second TRP in example 450). The coefficient matrix is a block-diagonal matrix and thus represents a semi-separate codebook for the TRPs. The TRPs perform CJT using one layer in example 450. Other examples may use additional layers (for example, two, three, four, or more layers).

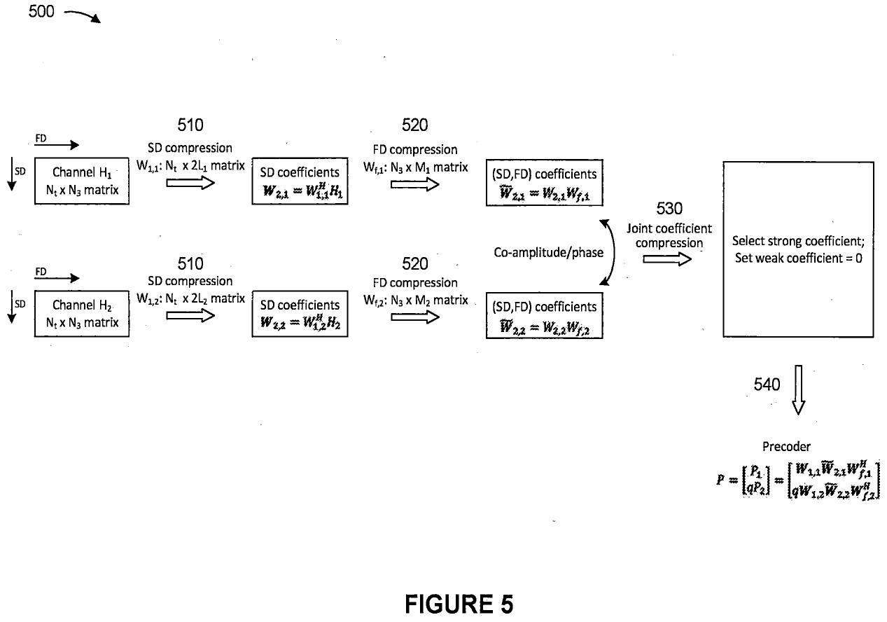

FIG. 5 is a diagram illustrating an example 500 of CJT in an mTRP configuration in accordance with the present disclosure. For example, as described herein, in a CJT configuration, different TRPs may jointly transmit the same message to a target UE on the same time and frequency resources, and the signals transmitted from different TRPs are jointly precoded with a prior phase alignment and close synchronization across the different TRPs such that the signals coherently combine at the target UE (for example, by exploiting phase and potential amplitude relations between channels associated with different TRPs). As a result, CJT in an mTRP configuration may improve coverage and improve average throughput via a high-performance backhaul and synchronization among TRPs. In general, CJT in an mTRP configuration may enabled using a codebook (for example, a Type-II codebook) that may be configured in a first mode or a second mode, which may differ with respect to whether an SD and/or FD basis selection is jointly applied or separately applied across different TRPs.

For example, in the first mode, a UE may transmit CSI feedback that includes an SD/FD basis selection per TRP or per TRP group, which allows an independent FD basis selection across N TRPs or N TRP groups, where N is a quantity of TRPs or TRP groups associated with the CJT configuration. For example, the SD/FD basis selection per TRP or per TRP group may be formulated as follows:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Alternatively, in the second mode, a UE may transmit CSI feedback that includes an SD basis selection per TRP or per TRP group (for example, where the TRP group includes a port group or a resource group) and a common or joint FD basis selection across N TRPs or N TRP groups. For example, the per-TRP SD basis selection and the common or joint FD basis selection may be formulated as follows:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

In some aspects, referring to FIG. 5, example 500 depicts a technique to derive a CJT precoder based on an SD/FD basis selection that is provided per TRP or TRP group (for example, in the first mode). For example, in an mTRP configuration that includes N TRPs, a UE may compute multiple channel matrices, H₁ to H_{N}, one for each TRP (for example, based on downlink reference signals transmitted by the different TRPs). As shown in FIG. 5, in a first operation 510, the UE may perform SD compression on the channel matrices associated with each respective TRP, which may produce a set of SD coefficients in a beam space for each respective TRP (for example, represented by W_{2,1} and W_{2,2} in example 500). In a second operation 520, the UE may perform FD compression on the set of SD coefficients in the beam space, which may produce a set of SD and FD coefficients associated with each respective TRP (for example, represented by \tilde{W}_{2,1} and \tilde{W}_{2,2} in example 500). As shown in FIG. 5, in an mTRP configuration, the SD and FD coefficients may provide a co-amplitude and co-phase across the multiple TRPs (for example, an inter-TRP co-amplitude and co-phase). In some aspects, in a third operation 530, the UE may apply joint coefficient compression to the SD and FD coefficients, where the joint coefficient compression may select a set of strongest coefficients and set one or more weak coefficients to zero (for example, to report only the strongest coefficients). In a fourth operation 540, the set of strongest coefficients may then be mapped to a precoder (for example, using a codebook structure).

In general, when the UE is configured to provide CSI feedback based on an SD basis selection that is provided per TRP or TRP group (for example, together with an FD basis selection in the first mode or separately from an FD basis selection in the second mode), the quantity of SD bases included in the SD basis selection can be the same or different for each respective TRP or TRP group. In a similar respect, the quantity of FD bases included in the FD basis selection can be the same or different for each respective TRP or TRP group. However, the total quantity of SD bases included in the SD basis selections across the multiple TRPs is subject to a fixed sum. For example, a network node may configure (for example, using radio resource control (RRC) signaling) a total quantity of SD bases across the multiple TRPs, which may be denoted Lₜₒₜₐₗ. Accordingly, in an mTRP configuration that includes two (2) TRPs, where L₁ is a quantity of SD bases in the SD basis selection for a first TRP and L₂ is a quantity of SD bases in the SD basis selection for a second TRP, L₁+L₂=Lₜₒₜₐₗ regardless of whether L₁≠L₂ or L₁=L₂. In some cases, the UE may also report additional amplitude scaling per TRP or TRP group and/or inter-TRP co-phase information as part of the W₂ matrices.

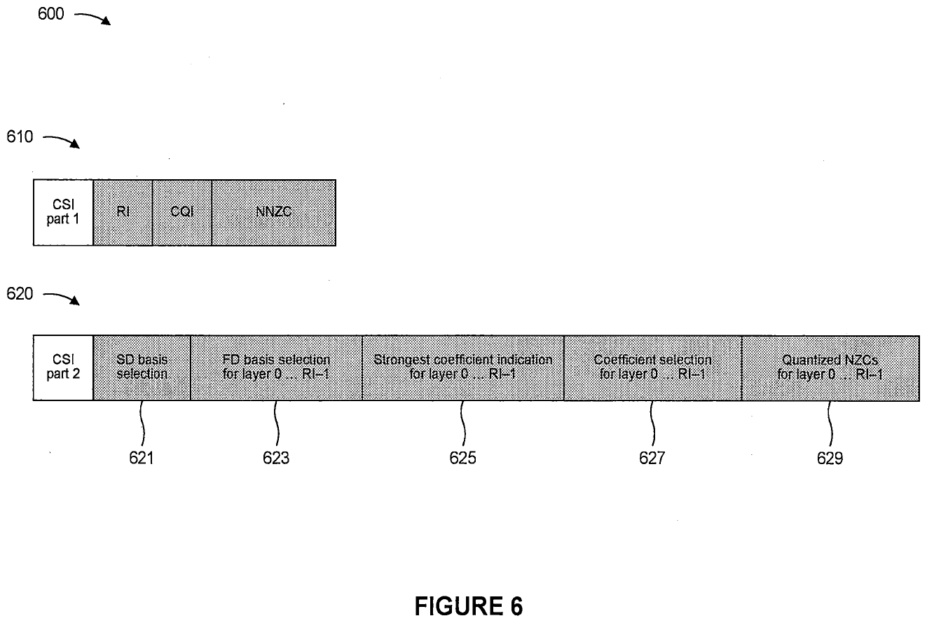

FIG. 6 is a diagram illustrating an example 600 of CSI associated with non-CJT in an mTRP configuration in accordance with the present disclosure. For example, the CSI has a large payload size to indicate various parameters in a non-CJT scenario, and is therefore partitioned into two parts. Furthermore, although the description provided herein relates to two-part CSI feedback in a non-CJT scenario, it will be appreciated that the CSI feedback may be reported in a different manner to enable CJT in an mTRP configuration (for example, including a per-TRP SD and/or FD basis selection and/or inter-TRP co-phasing parameters, among other examples).

For example, the CSI feedback includes CSI part one 610, which includes a rank indicator (RI), a CQI value, and a field indicating a number of non-zero coefficients (NNZC). Furthermore, the CSI feedback includes CSI part two 620, which includes an SD basis selection 621, an FD basis selection 623, a strongest coefficient indication (SCI) 625, a coefficient selection 627, and quantized non-zero coefficients (NZCs) 629 (note that the CSI part two 620 is not necessarily packed in the order shown in FIG. 6). In general, the CSI part one 610 is more significant than the CSI part two 620, whereby the CSI part one 610 has a smaller and fixed payload size and is transmitted with a higher reliability than the CSI part two 620, which has a variable payload size that depends on the content of the CSI part one 610. For example, because the FD basis selection 623, the SCI 625, the coefficient selection 627, and the quantized NZCs 629 may be provided for layer zero (0) through RI−1, the RI (or quantity of layers) indicated in the CSI part one 610 and/or the NNZC value indicated in the CSI part one 610 may determine the payload size of the CSI part two 620. The FD basis selection 623 may include one or more parameters that indicate a selection of M FD bases out of a configured quantity of FD bases for W_{f} per layer, the SCI 625 may indicate the locations of the strongest coefficient in \tilde{W}₂ per layer, the coefficient selection 627 may indicate the location of NZCs within \tilde{W}₂ per layer, and the quantized NZCs 629 may indicate amplitude and/or phase quantization for NZCs (for example, a differential quantization based on the SCI 625).

Furthermore, the SD basis selection 621 includes a set of parameters that are used to select L beams out of N₁N₂O₁O₂ total beams for W₁, where N₁ represents a quantity of antenna elements in a horizontal direction, N₂ represents a quantity of antenna elements in a vertical direction, O₁ represents a sweeping step in the horizontal direction, and O₂ represents a sweeping step in the vertical direction (for example, N₁N₂ represents the total quantity of SD bases, or candidate beams, per TRP or TRP group, and O₁O₂ is an oversampling factor that may have a relatively high value to enable beam sweeping in smaller steps, or finer angles, or a relatively low value to enable beam sweeping in larger steps, or coarser angles). For example, the SD basis selection 621 includes a beam group parameter, denoted i_{1,1}, where i_{1,1}:log₂ O₁O₂, and an SD basis selection indicator (or beam indication), denoted i_{1,2}, where i_{1,2}:

$$⌈ {log}_{2} ( \begin{matrix}{N}_{1} {N}_{2} \\ L\end{matrix} ) ⌉ .$$

As described in further detail herein, the UE may need to encode the SD basis selection indicator by mapping a beam index to the SD basis selection indicator.

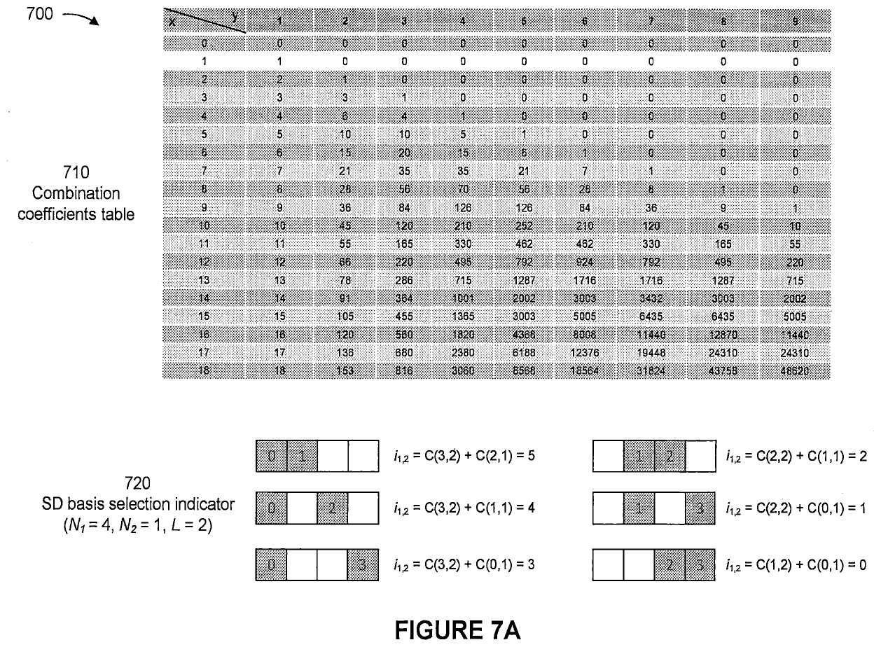

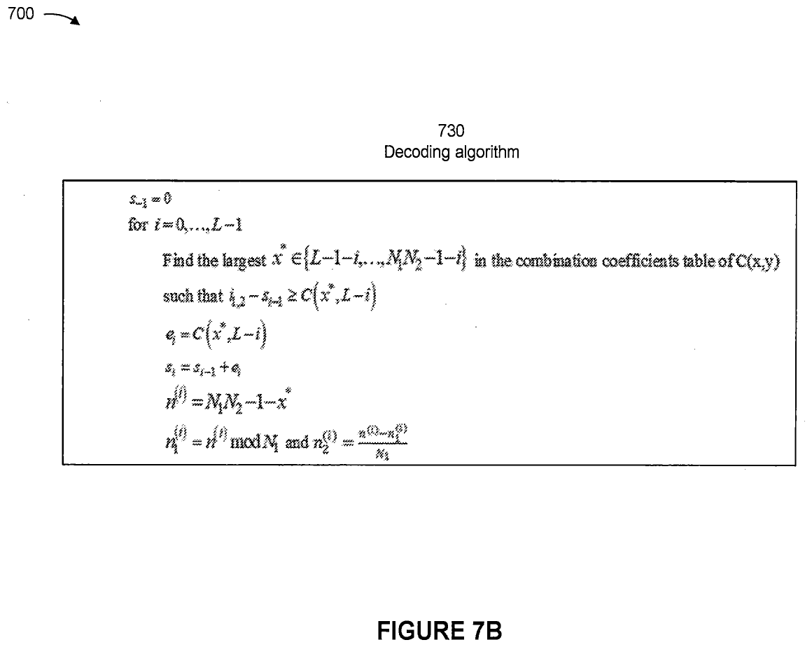

FIGS. 7A-7B are diagrams illustrating an example 700 of encoding and decoding an SD basis selection indicator that may be included in CSI to enable CJT in an mTRP configuration in accordance with the present disclosure. For example, as described herein, the SD basis selection indicator may generally indicate a selection of L beams out of a total quantity of N₁N₂ candidate beams by i_{1,2}∈

$$\{ 0 , 1 , … , ( \begin{matrix}{N}_{1} {N}_{2} \\ L\end{matrix} ) - 1 \} .$$

In general, to encode the SD basis selection indicator (for example, mapping a beam index to the i_{1,2} parameter), the UE may determine an SD basis index in a two-dimensional (2D) grid that includes N₁N₂ candidate beams (for example, the 2D grid may include N₁ columns and N₂ rows that correspond to entries in a combination coefficients table 710). For example, the i-th SD basis may be denoted by an index pair

$$( {n}_{1}^{( i )} , {n}_{2}^{( i )} )$$

where

$${n}_{1}^{( i )}$$

### ∈{0, 1, . . . , N₁−1} and

$${n}_{2}^{( i )}$$

∈{0, 1, . . . , N₂−1} and i=0, 1, . . . , L−1. The UE then determines the SD basis selection indicator, i_{1,2}, using the following formula:

$${i}_{1 , 2} = {\sum }_{i = 0}^{L - 1} C ( {N}_{1} {N}_{2} - 1 - {n}^{( i )} , L - i )$$

where

$${n}^{( i )} = {N}_{1} {n}_{2}^{( i )} + {n}_{1}^{( i )} and C ( x , y ) = ( \begin{matrix}x \\ y\end{matrix} )$$

for x≥ y or zero (0) for x<y, where C(x,y) is a subset of the combination coefficients table 710 that depends on the values of x and y. For example, in FIG. 7A, reference number 720 depicts an example of an SD basis selection indicator that is used to select two (2) beams (L=2) out of four (4) candidate beams (N₁N₂=4) based on four (4) antenna elements in a horizontal direction (N₁=4) and one (1) antenna element in a vertical direction (N₂=1). As shown, there are six possible choices for the value of the SD basis selection indicator, where each SD basis selection indicator is a sum of a first beam index and a second beam index. For example, in FIG. 7A, beam index zero corresponds to C(3,2) in the combination coefficients table 710, which has a value of three (3), and beam index one corresponds to C(2,1) in the combination coefficients table 710, which has a value of two (2), whereby a selection of beam index zero and beam index one is indicated by a value of five (5). In general, the mapping of a beam index to C(x,y) (for example, corresponding to an entry in the combination coefficients table 710) is not fixed, but dependent on an index i. For example, beam index i is mapped to C(2,1) for i=0 or to C(2,2) for i=3. In another example, in FIG. 7A, beam index two corresponds to C(1,1) in the combination coefficients table 710, which has a value of one (1), whereby a selection of beam index zero and beam index two is indicated by a value of four (4). Accordingly, depending on the sum of the values in the combination coefficients table 710 that map to the/beam indexes that are selected from the N₁N₂ candidate beams, the UE may determine the value of the SD basis selection indicator to include in the CSI feedback that enables CJT in the corresponding mTRP configuration. Furthermore, referring to FIG. 7B, reference number 730 depicts a decoding algorithm that a network node may apply to determine the SD basis indexes from the SD basis selection indicator included in the CSI feedback.

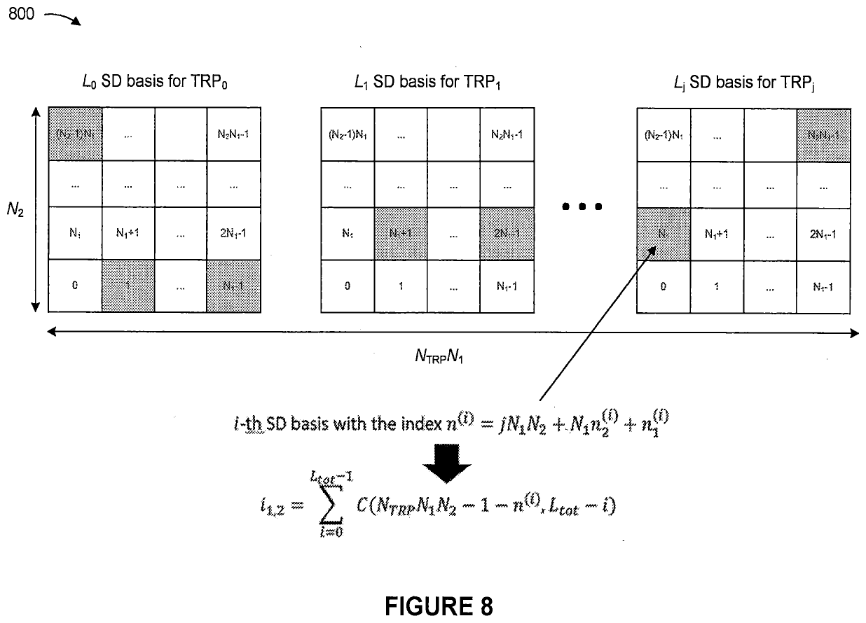

FIG. 8 is a diagram illustrating an example 800 of an SD basis selection indicator for CJT in an mTRP configuration in accordance with the present disclosure. As described herein, example 800 relates to a potential technique to extend a combination coefficients table associated with reporting an SD basis selection indicator per TRP or per TRP group (for example, combination coefficients table 710) to support a joint SD basis selection across multiple TRPs. However, such an approach suffers from drawbacks, as described in more detail herein. For example, as shown in FIG. 7A, the combination coefficients table associated with reporting an SD basis selection indicator per TRP or per TRP group includes a maximum of nineteen (19) rows indexed from zero (0) through eighteen (18) and a maximum of ten (10) columns indexed from zero (0) through nine (9). Accordingly, the notation C(x,y) may represent a subset of the combination coefficients table, where x is row index and y is a column index in C(x,y), where x has a maximum value of 18 and y has a maximum value of 9. Furthermore, the combination coefficients table is structured such that a value in row n and column n, denoted C(n,m), is determined by C(n,m)=C(n−1,m)+C(n−1,m−1). Due to this design of the combination coefficients table, extending the combination coefficients table to support a joint SD basis selection indicator across multiple TRPs may be infeasible.

For example, in order to provide a joint SD basis selection indicator, i_{1,2}, that enables CJT across multiple TRPs, the UE may generally use

$$⌈ {log}_{2} ( \begin{matrix}{N}_{TRP} {N}_{1} {N}_{2} \\ {L}_{tot}\end{matrix} ) ⌉$$

bits to indicate a selection of Lₜₒₜₐₗ SD bases out of a total of N_{TRP}N₁N₂ SD bases, where N_{TRP} is a quantity of TRPs associated with the CJT configuration and

$${L}_{total} = {\sum }_{m = 1}^{{N}_{TRP}} {L}_{m} ,$$

which is an RRC-configured total quantity of SD bases across the multiple TRPs. In such examples, the Lₘ value that represents the quantity of SD bases (or beams) that are selected for each TRP can be implicitly determined from the joint SD basis selection indicator and the UE does not need to separately report the Lₘ value for each TRP. However, the joint SD basis selection indicator would likely require an extension to the combination coefficients table that is defined for reporting a per-TRP SD basis selection indicator in order to support larger x and y values. For example, the combination coefficients table for reporting a per-TRP SD basis selection indicator includes a maximum of 19 rows based on N₁N₂ having a maximum value of 16. However, in a worst case scenario where N_{TRP}=4, N₁=4, N₂=4, the maximum value of x could be as high as sixty-four (64) (N_{TRP}N₁N₂=64), which is much larger than the existing maximum value. As a result, the extended combination coefficients table would have very large memory or storage requirements, in addition to increased complexity to encode the joint SD basis selection indicator at the UE and to decode the joint SD basis selection indicator at the network node due to C(x,y) potentially having a very large value. For example, in an extended combination coefficients table with 64 rows to support the worst case scenario where N_{TRP}N₁N₂=64, the entry appearing at C(64,8) would have a value of 4,426,165,368, which would require thirty-three (33) bits to represent the value, which would significantly add to the payload size of the CSI feedback.

For example, in a scenario where the combination coefficients table is extended to support a joint SD basis selection indicator, the UE may first determine, for each TRP, an SD basis index in a 2D grid of N₁N₂ beams, where the i-th SD beam that is selected for TRP j is defined by an index pair

$$( {n}_{1}^{( i )} , {n}_{2}^{( i )} )$$

where

$${n}_{1}^{( i )}$$

### ∈{0, 1, . . . , N₁−1} and

$${n}_{2}^{( i )}$$

∈{0, 1, . . . , N₂−1} and i=0, 1, . . . , L−1 and j=0, . . . , N_{TRP}−1. The UE may then determine the joint SD basis selection indicator, i_{1,2}, as follows:

$${\sum }_{i = 0}^{{L}_{tot} - 1} C ( {N}_{TRP} {N}_{1} {N}_{2} - 1 - {n}^{( i )} , {L}_{tot} - i )$$

where

$${n}^{( i )} = {jN}_{1} {N}_{2} + {N}_{1} {n}_{2}^{( i )} + {n}_{1}^{( i )} and C ( x , y ) = ( \begin{matrix}x \\ y\end{matrix} ) for x \geq y ;$$

0 for x<y based on the extended combination coefficients table. The network node may then use the same decoding algorithm shown in FIG. 7B to identify the SD basis indexes from the i_{1,2} parameter reported by the UE, except that N₁N₂ is replaced with N_{TRP}N₁N₂ and the network node identifies the TRP index j and the SD basis index

$$( {n}_{1}^{( i )} , {n}_{2}^{( i )} )$$

for the i-th SD beam (i=0, 1, . . . , L−1) indicated by the i_{1,2} parameter using the equations

$$j = \frac{{n}^{( i )}}{{N}_{1} {N}_{2}} , {n}_{1}^{( i )} = {n}^{( i )} mod {N}_{1} {n}_{2}^{( i )} = \frac{{n}^{( i )} - {n}_{1}^{( i )}}{{N}_{1}} mod {N}_{2} .$$

Furthermore, referring to FIG. 8, example 800 depicts how a joint SD basis selection indicator may be represented based on an extension to the combination coefficients table. As shown, the value of N₁ is scaled in accordance with the value of N_{TRP}, and the UE may select Lₘ SD bases per TRP. As a result, the i-th SD basis with the index

$${n}^{( i )} = {jN}_{1} {N}_{2} + {N}_{1} {n}_{2}^{( i )} + {n}_{1}^{( i )}$$

is selected for TRP j and may be mapped to a joint SD basis selection indicator using the extended combination coefficients table as follows:

$${i}_{1 , 2} = {\sum }_{i = 0}^{{L}_{tot} - 1} C ( {N}_{TRP} {N}_{1} {N}_{2} - 1 - {n}^{( i )} , {L}_{total} - i )$$

Accordingly, it will be appreciated that extending the combination coefficients table to support a joint SD basis selection indicator may significantly add to implementation complexity at the UE and network node in addition to creating potential issues such as increased memory or storage requirements and larger CSI feedback.

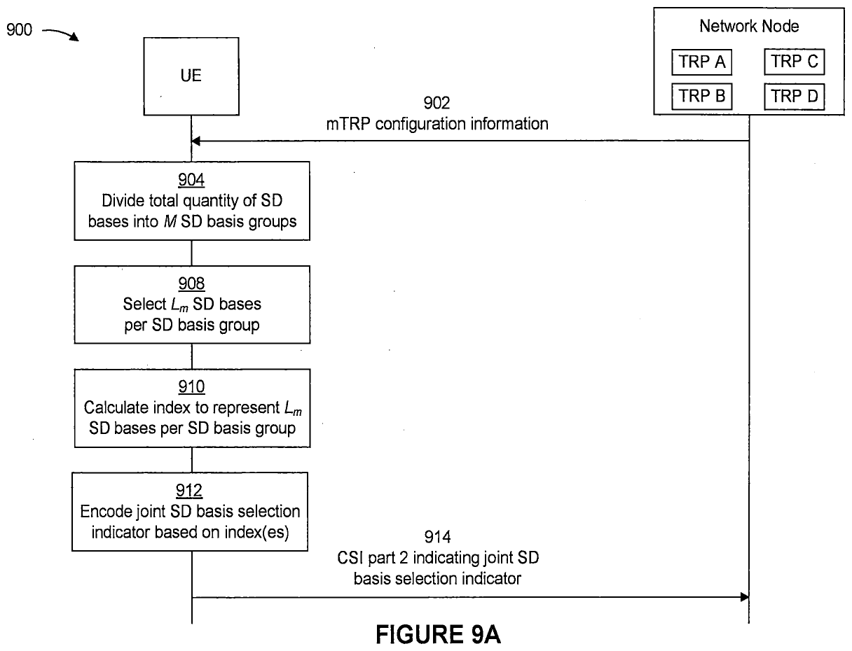

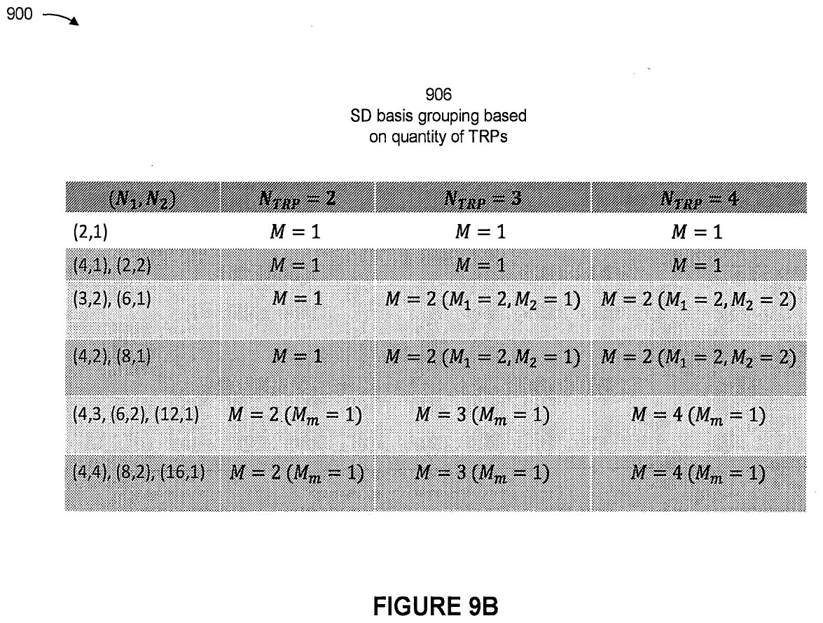

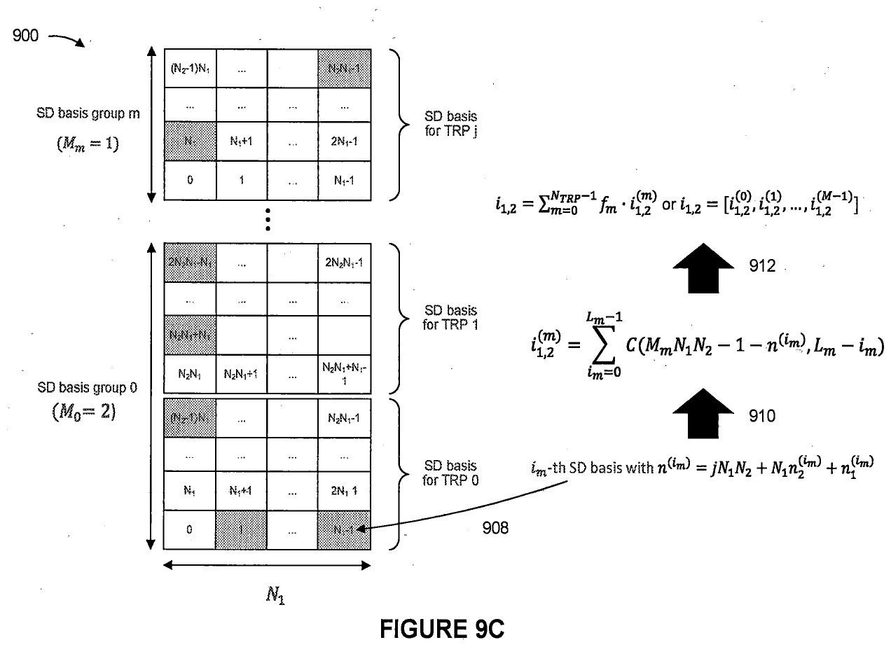

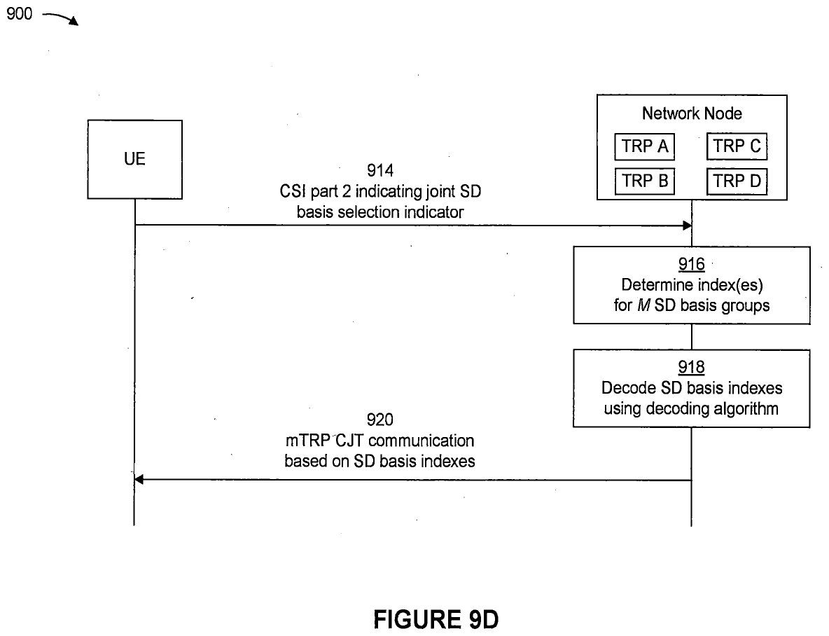

FIGS. 9A-9D are diagrams illustrating examples 900 associated with encoding and decoding an SD basis selection for mTRP communication in accordance with the present disclosure. As shown in FIGS. 9A-9D, examples 900 include communication between a UE (for example, UE 120) and a network node (for example, network node 110) that includes or controls multiple TRPs (for example, TRP A, TRP B, TRP C, and TRP D in the illustrated examples 900, although it will be appreciated that fewer or more than four TRPs may be used in other examples) . . . . In some aspects, the UE and the network node may communicate in a wireless network, such as wireless network 100. The network node and the UE may communicate via a wireless access link, which may include an uplink and a downlink.

As shown in FIG. 9A, in a first operation 902, the network node may transmit, and the UE may receive, mTRP configuration information. For example, in some aspects, the mTRP configuration information may indicate values for N_{TRP}, N₁, and N₂, which may define a total quantity of SD bases associated with the multiple TRPs that are associated with a CJT configuration. Accordingly, in a second operation 904, the UE may partition, divide, or otherwise group the total quantity of SD bases, which may be denoted N_{TRP}N₁N₂, into M SD basis groups, where each SD basis group includes a quantity of SD bases that satisfies (for example, does not exceed) a threshold. For example, FIG. 9B illustrates an example 906 of SD basis groupings for different quantities of TRPs and different values for N₁N₂ in a case where the threshold (or maximum quantity) of SD bases per SD basis group is sixteen (16). In such examples, as shown, the UE may divide the total quantity of SD bases into one SD basis group (M=1) if N_{TRP} has a value of 2 and N₁N₂ has a value of 2 (the first row), 4 (the second row), 6 (the third row), or 8 (the fourth row), because the total quantity of SD bases in each such case does not exceed the maximum value of 16. In other examples, the UE may divide the total quantity of SD bases into two SD basis groups (M=2) if N_{TRP} has a value of 2 and N₁N₂ has a value of 12 (the fifth row) or 16 (the last row), into two SD basis groups if N_{TRP} has a value of 3 and N₁N₂ has a value of 6 or 8, into three SD basis groups if N_{TRP} has a value of 3 and N₁N₂ has a value of 12 or 16, and so on, such that each SD basis group includes 16 or fewer SD bases. Furthermore, in some aspects, the grouping of the total SD bases into the M SD basis groups may be based on TRP (for example, where there is more than one SD basis group). For example, the first M₁ TRPs may be included in a first SD basis group, the second M₂ TRPs may be included in a second SD basis group, and so on, where MₘN₁N₂≤16 (or other threshold) and m=0, . . . , M−1.

As further shown in FIG. 9A, in a third operation 908, the UE may select, for each of the M SD basis groups, a quantity of SD bases, denoted as Lₘ, where

$${L}_{total} = {\sum }_{m = 0}^{M - 1} {L}_{m}$$

and each corresponding SD basis index is denoted as

$$( {n}_{1}^{( {i}_{m} )} , {n}_{2}^{( {i}_{m} )} ) ,$$

where

$${n}_{1}^{( {i}_{m} )}$$

### ∈{0, 1, . . . , N′₁−1},

$${n}_{2}^{( {i}_{m} )}$$

∈{0, 1, . . . ,

$${N}_{2}^{′} - 1 \} ,$$

and iₘ=0, . . . , Lₘ−1, and

$${N}_{1}^{′} = {N}_{1} ,$$

$${N}_{2}^{′} = {M}_{m} {N}_{2} .$$

For example, the SD basis index may correspond to an index that is used to identify an entry in a combination coefficients table, as described in more detail elsewhere herein. As further shown in FIG. 9A, in a fourth operation 910, the UE may calculate an index to represent the Lₘ SD bases that are selected for each respective SD basis group. For example, the index that is calculated to represent the Lₘ SD bases that are selected for each respective SD basis group may be denoted as

$${i}_{1 , 2}^{( m )} ,$$

which may be calculated using the following expression:

$${\sum }_{{i}_{m} = 0}^{{L}_{m} - 1} C ( {M}_{m} {N}_{1} {N}_{2} - 1 - {n}^{( {i}_{m} )} , {L}_{m} - {i}_{m} )$$

where

$${n}^{( {i}_{m} )} = {jN}_{1} {N}_{2} + {N}_{1} {n}_{2}^{( {i}_{m} )} + {n}_{1}^{( {i}_{m} )} , j = 0 , 1 , … {M}_{m} - 1 C ( x , y ) = ( \begin{matrix}x \\ y\end{matrix} )$$

for x≥y; 0 for x<y. In this way, the

$${i}_{1 , 2}^{( m )}$$

index that is calculated to represent the Lₘ SD bases that are selected for each respective SD basis group may be determined using the same combination coefficient table that is used for non-CJT cases.

As further shown in FIG. 9A, in a fifth operation 912, the UE may combine the indexes that represent the Lₘ selected SD bases for each respective SD basis group to encode a single joint SD basis selection indicator across the multiple TRPs. For example, in some aspects, the UE may encode the joint SD basis selection indicator, i_{1,2}, using a scaling factor, as follows:

$${i}_{1 , 2} = {\sum }_{m = 0}^{{N}_{TRP} - 1} {f}_{m} \cdot {i}_{1 , 2}^{( m )}$$

where f(m) is a scaling factor based on Lₘ. For example, in some aspects,

$${f}_{m} = {\prod }_{{m}^{′} = 0}^{m - 1} C ( {M}_{{m}^{′}} {N}_{1} {N}_{2} , {L}_{{m}^{′}} )$$

for m>0; 1 for m=0.

Alternatively, in some aspects, the UE may encode the joint SD basis selection indicator, i_{1,2}, based on a vector, as follows:

$${i}_{1 , 2} = [ {i}_{1 , 2}^{( 0 )} , {i}_{1 , 2}^{( 1 )} , … , {i}_{1 , 2}^{( M - 1 )} ]$$

where

$${i}_{1 , 2}^{( m )}$$

has a variable bit-width dependent on Lₘ. For example, in some aspects, the value of

$${i}_{1 , 2}^{( m )}$$

may generally include

$$⌈ {log}_{2} ( \begin{matrix}{M}_{m} {N}_{1} {N}_{2} \\ {L}_{m}\end{matrix} ) ⌉$$

bits.

For example, FIG. 9C illustrates an example of the various operations that the UE may perform to encode the joint SD basis selection indicator based on the indexes that represent the Lₘ selected SD bases for each respective SD basis group. For example, referring to FIG. 9C, the arrow corresponds to the third operation 908 described above, pointing to the iₘ-th SD basis with

$${n}^{( {i}_{m} )} = {jN}_{1} {N}_{2} + {N}_{1} {n}_{2}^{( {i}_{m} )} + {n}_{1}^{( {i}_{m} )}$$

assuming the iₘ-th SD basis is selected for the SD basis group j. Accordingly, the UE may compute the corresponding basis index for each of the Lₘ SD bases that are selected across the M SD basis groups, which may be used to calculate the indexes,

$${i}_{1 , 2}^{( m )} ,$$

that represent the Lₘ SD bases that are selected for each SD basis group in the fourth operation 910. As further shown, the indexes,

$${i}_{1 , 2}^{( m )} ,$$

are then used in the fifth operation 912 to encode the joint SD basis selection indicator, i_{1,2}, either using a scaling factor or a vector representation. Accordingly, referring again to FIG. 9A, the UE may then transmit CSI feedback to the network node in a sixth operation 914, where the CSI feedback may include CSI part one that includes an RI, a CQI value, and an NNZC value and CSI part two that carries the joint SD basis selection indicator, i_{1,2}, associated with multiple TRPs in addition to one or more indicators such as an FD basis selection, an SCI, a coefficient selection, and/or quantized NZCs, among other examples.

FIG. 9D depicts an example of techniques that may be applied at the network node to decode SD basis indexes associated with multiple TRPs based on the joint SD basis selection indicator described herein. For example, in the sixth operation 914, the network node may receive the CSI feedback transmitted by the UE. In a seventh operation 916, the network node may determine one or more indexes for the M SD basis groups. For example, in the seventh operation 916, the network node may determine the value of M, or the quantity of SD basis groups, based on the value of N_{TRP}, N₁ and N₂, and the quantity of TRPs in each SD basis group Mₘ, where m=0, . . . , M−1. Accordingly, based on the quantity of SD basis groups and the value of the joint SD basis selection indicator received from the UE, the network node may determine the index corresponding to the

$${i}_{1 , 2}^{( m )}$$

parameter associated with each respective SD basis group. For example, where the joint SD basis selection indicator is encoded based on a scaling factor, the network node may determine the index corresponding to the

$${i}_{1 , 2}^{( m )}$$

parameter associated with each respective SD basis group based on the following equation:

$${i}_{1 , 2} = {\sum }_{m = 0}^{{N}_{TRP} - 1} {f}_{m} \cdot {i}_{1 , 2}^{( m )}$$

Alternatively, where the joint SD basis selection indicator is encoded based on a vector, the network node may determine the index corresponding to the

$${i}_{1 , 2}^{( m )}$$

parameter associated with each respective SD basis group based on the following equation:

$${i}_{1 , 2} = [ {i}_{1 , 2}^{( 0 )} , {i}_{1 , 2}^{( 1 )} , … , {i}_{1 , 2}^{( M - 1 )} ]$$

As further shown in FIG. 9D, in an eighth operation 918, the network node may decode the SD basis indexes for each SD basis group based on the

$${i}_{1 , 2}^{( m )}$$

parameter associated with each respective SD basis group. For example, in some aspects, the network node may use the decoding algorithm depicted in FIG. 7B to determine the SD basis indexes for each SD basis group from the

$${i}_{1 , 2}^{( m )}$$

parameter associated with each respective SD basis group and an associated TRP index, denoted j. In this way, in a ninth operation 920, the network node may configure suitable precoders at each TRP based on the SD basis indexes for each SD basis group and the associated TRP indexes to enable CJT across multiple TRPs.

FIG. 10 is a flowchart illustrating an example process 1000 performed, for example, by a UE that supports mTRP communication in accordance with the present disclosure. Example process 1000 is an example where the UE (for example, UE 120) performs operations associated with encoding an SD basis selection for mTRP communication.

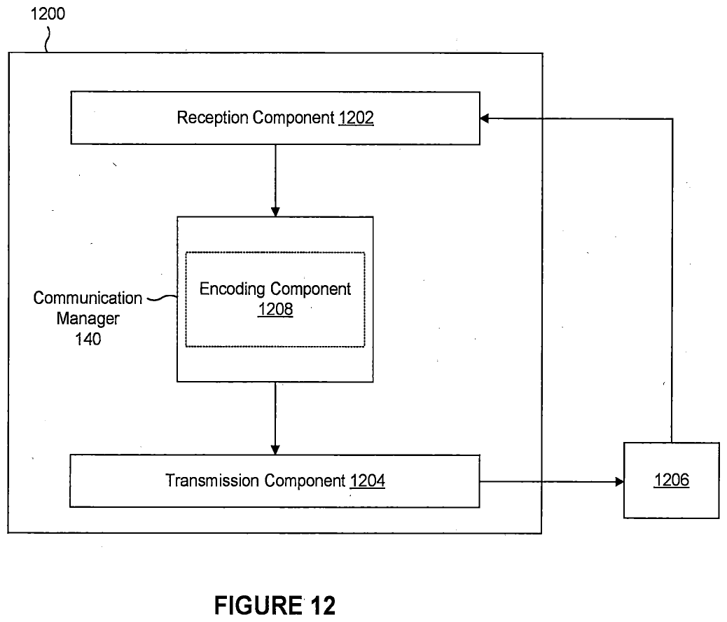

As shown in FIG. 10, in some aspects, process 1000 may include grouping a total quantity of SD bases associated with multiple TRPs into one or more SD basis groups, each SD basis group including a set of SD bases (block 1010). For example, the UE (such as by using communication manager 140 or encoding component 1208, depicted in FIG. 12) may group a total quantity of SD bases associated with multiple TRPs into one or more SD basis groups, each SD basis group including a set of SD bases, as described above.

As further shown in FIG. 10, in some aspects, process 1000 may include selecting, for each respective SD basis group of the one or more SD basis groups, one or more SD bases from the respective set of SD bases included in the respective SD basis group (block 1020). For example, the UE (such as by using communication manager 140 or encoding component 1208, depicted in FIG. 12) may select, for each respective SD basis group of the one or more SD basis groups, one or more SD bases from the respective set of SD bases included in the respective SD basis group, as described above.

As further shown in FIG. 10, in some aspects, process 1000 may include identifying, for each respective SD basis group of the one or more SD basis groups, an index that represents the one or more SD bases selected for the respective SD basis group (block 1030). For example, the UE (such as by using communication manager 140 or encoding component 1208, depicted in FIG. 12) may identify, for each respective SD basis group of the one or more SD basis groups, an index that represents the one or more SD bases selected for the respective SD basis group, as described above.

As further shown in FIG. 10, in some aspects, process 1000 may include transmitting, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group (block 1040). For example, the UE (such as by using communication manager 140 or transmission component 1204, depicted in FIG. 12) may transmit, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group, as described above.

Process 1000 may include additional aspects, such as any single aspect or any combination of aspects described below or in connection with one or more other processes described elsewhere herein.

In a first additional aspect, the total quantity of SD bases associated with the multiple TRPs is based at least in part on a quantity of the multiple TRPs and one or more parameters that indicate a total quantity of SD bases per TRP.

In a second additional aspect, alone or in combination with the first aspect, the one or more SD basis groups each include a quantity of SD bases that satisfies a threshold.

In a third additional aspect, alone or in combination with one or more of the first and second aspects, the one or more SD basis groups each include one or more sets of SD bases that are respectively associated with one or more TRPs included among the multiple TRPs.

In a fourth additional aspect, alone or in combination with one or more of the first through third aspects, the one or more SD bases selected for each respective SD basis group are each associated with a corresponding basis index.

In a fifth additional aspect, alone or in combination with one or more of the first through fourth aspects, the index that represents the one or more SD bases selected for each respective SD basis group is based at least in part on one or more combination coefficient values that map to the corresponding basis indexes associated with the one or more SD bases selected for the respective SD basis group.

In a sixth additional aspect, alone or in combination with one or more of the first through fifth aspects, the joint SD basis selection indicator encodes the index that represents the one or more SD bases selected for each of the one or more SD basis groups in accordance with a scaling factor.

In a seventh additional aspect, alone or in combination with one or more of the first through sixth aspects, the scaling factor has a value that is based at least in part on a quantity of the one or more SD bases that are selected for each of the one or more SD basis groups.

In an eighth additional aspect, alone or in combination with one or more of the first through seventh aspects, the joint SD basis selection indicator encodes the index that represents the one or more SD bases selected for each of the one or more SD basis groups in accordance with a vector.

In a ninth additional aspect, alone or in combination with one or more of the first through eighth aspects, each entry in the vector has a variable bit width that is based at least in part on a quantity of the one or more SD bases that are selected for each of the one or more SD basis groups.

In a tenth additional aspect, alone or in combination with one or more of the first through ninth aspects, the CSI includes information that indicates a quantity of the one or more SD bases that are selected for each of the one or more SD basis groups.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a network node that supports mTRP communication in accordance with the present disclosure. Example process 1100 is an example where the network node (for example, network node 110) performs operations associated with decoding an SD basis selection for mTRP communication.

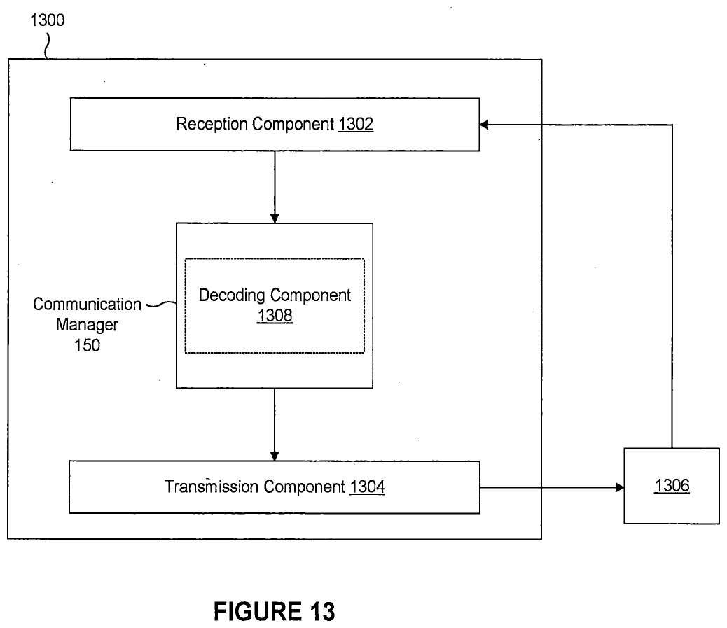

As shown in FIG. 11, in some aspects, process 1100 may include receiving, from a UE, CSI that includes a joint SD basis selection indicator for multiple TRPs (block 1110). For example, the network node (such as by using communication manager 150 or reception component 1302, depicted in FIG. 13) may receive, from a UE, CSI that includes a joint SD basis selection indicator for multiple TRPs, as described above.

As further shown in FIG. 11, in some aspects, process 1100 may include decoding, for each of one or more SD basis groups, a respective index that represents one or more SD bases selected for the respective SD basis group based at least in part on the joint SD basis selection indicator (block 1120). For example, the network node (such as by using communication manager 150 or decoding component 1308, depicted in FIG. 13) may decode, for each of one or more SD basis groups, a respective index that represents one or more SD bases selected for the respective SD basis group based at least in part on the joint SD basis selection indicator, as described above.

As further shown in FIG. 11, in some aspects, process 1100 may include decoding, for each of the one or more SD basis groups, one or more SD basis indexes based at least in part on the respective index that represents the one or more SD bases selected for the respective SD basis group and an associated TRP index (block 1130). For example, the network node (such as by using communication manager 150 or decoding component 1308, depicted in FIG. 13) may decode, for each of the one or more SD basis groups, one or more SD basis indexes based at least in part on the respective index that represents the one or more SD bases selected for the respective SD basis group and an associated TRP index, as described above.

Process 1100 may include additional aspects, such as any single aspect or any combination of aspects described below or in connection with one or more other processes described elsewhere herein.

In a first additional aspect, decoding the respective index that represents the one or more SD bases selected for each respective SD basis group is based at least in part on a total quantity of the multiple TRPs, one or more parameters that indicate a total quantity of SD bases per TRP, and a quantity of TRPs in each SD basis group.

In a second additional aspect, alone or in combination with the first aspect, the one or more SD basis groups each include a quantity of SD bases that satisfies a threshold.

In a third additional aspect, alone or in combination with one or more of the first and second aspects, the one or more SD basis groups each include one or more sets of SD bases that are respectively associated with one or more TRPs included among the multiple TRPs.

In a fourth additional aspect, alone or in combination with one or more of the first through third aspects, the joint SD basis selection indicator encodes one or more respective indexes that represent the one or more SD bases selected for each of the one or more SD basis groups in accordance with a scaling factor.

In a fifth additional aspect, alone or in combination with one or more of the first through fourth aspects, the scaling factor has a value that is based at least in part on a quantity of the one or more SD bases that are selected for each of the one or more SD basis groups.

In a sixth additional aspect, alone or in combination with one or more of the first through fifth aspects, the joint SD basis selection indicator encodes one or more respective indexes that represent the one or more SD bases selected for each of the one or more SD basis groups in accordance with a vector.

In a seventh additional aspect, alone or in combination with one or more of the first through sixth aspects, each entry in the vector has a variable bit width that is based at least in part on a quantity of the one or more SD bases that are selected for each of the one or more SD basis groups.

In an eighth additional aspect, alone or in combination with one or more of the first through seventh aspects, the CSI includes information that indicates a quantity of the one or more SD bases that are selected for each of the one or more SD basis groups.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports mTRP communication in accordance with the present disclosure. The apparatus 1200 may be a UE, or a UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to perform one or more operations described herein in connection with FIGS. 9A-9D. Additionally or alternatively, the apparatus 1200 may be configured to perform one or more processes described herein, such as process 1000 of FIG. 10. In some aspects, the apparatus 1200 may include one or more components of the UE described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, and/or a memory of the UE described above in connection with FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, and/or a memory of the UE described above in connection with FIG. 2. In some aspects, the transmission component 1204 may be co-located with the reception component 1202 in a transceiver.

The communication manager 140 may group a total quantity of SD bases associated with multiple TRPs into one or more SD basis groups, each SD basis group including a set of SD bases. The communication manager 140 may select, for each respective SD basis group of the one or more SD basis groups, one or more SD bases from the respective set of SD bases included in the respective SD basis group. The communication manager 140 may identify, for each respective SD basis group of the one or more SD basis groups, an index that represents the one or more SD bases selected for the respective SD basis group. The communication manager 140 may transmit or may cause the transmission component 1204 to transmit, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as an encoding component 1208. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The encoding component 1208 may group a total quantity of SD bases associated with multiple TRPs into one or more SD basis groups, each SD basis group including a set of SD bases. The encoding component 1208 may select, for each respective SD basis group of the one or more SD basis groups, one or more SD bases from the respective set of SD bases included in the respective SD basis group. The encoding component 1208 may identify, for each respective SD basis group of the one or more SD basis groups, an index that represents the one or more SD bases selected for the respective SD basis group. The transmission component 1204 may transmit, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports mTRP communication in accordance with the present disclosure. The apparatus 1300 may be a network node, or a network node may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to perform one or more operations described herein in connection with FIGS. 9A-9D. Additionally or alternatively, the apparatus 1300 may be configured to perform one or more processes described herein, such as process 1100 of FIG. 11. In some aspects, the apparatus 1300 may include one or more components of the network node described above in connection with FIG. 2.

The reception component 1302 may receive communications, such as reference signals, control information, and/or data communications, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, and/or a memory of the network node described above in connection with FIG. 2.

The transmission component 1304 may transmit communications, such as reference signals, control information, and/or data communications, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, and/or a memory of the network node described above in connection with FIG. 2. In some aspects, the transmission component 1304 may be co-located with the reception component 1302 in a transceiver.

The communication manager 150 may receive or may cause the reception component 1302 to receive, from a UE, CSI that includes a joint SD basis selection indicator for multiple TRPs. The communication manager 150 may decode, for each of one or more SD basis groups, a respective index that represents one or more SD bases selected for the respective SD basis group based at least in part on the joint SD basis selection indicator. The communication manager 150 may decode, for each of the one or more SD basis groups, one or more SD basis indexes based at least in part on the respective index that represents the one or more SD bases selected for the respective SD basis group and an associated TRP index. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a decoding component 1308. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive, from a UE, CSI that includes a joint SD basis selection indicator for multiple TRPs. The decoding component 1308 may decode, for each of one or more SD basis groups, a respective index that represents one or more SD bases selected for the respective SD basis group based at least in part on the joint SD basis selection indicator. The decoding component 1308 may decode, for each of the one or more SD basis groups, one or more SD basis indexes based at least in part on the respective index that represents the one or more SD bases selected for the respective SD basis group and an associated TRP index.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a UE, comprising: grouping a total quantity of SD bases associated with multiple TRPs into one or more SD basis groups, each SD basis group including a set of SD bases; selecting, for each respective SD basis group of the one or more SD basis groups, one or more SD bases from the respective set of SD bases included in the respective SD basis group; identifying, for each respective SD basis group of the one or more SD basis groups, an index that represents the one or more SD bases selected for the respective SD basis group; and transmitting, to a network node, CSI that includes a joint SD basis selection indicator for the multiple TRPs, the joint SD basis selection indicator indicating, for each respective SD basis group of the one or more SD basis groups, the respective index representing the one or more SD bases selected for the respective SD basis group.
Aspect 2: The method of Aspect 1, wherein the total quantity of SD bases associated with the multiple TRPs is based at least in part on a quantity of the multiple TRPs and one or more parameters that indicate a total quantity of SD bases per TRP.
Aspect 3: The method of any of Aspects 1-2, wherein the one or more SD basis groups each include a quantity of SD bases that satisfies a threshold.
Aspect 4: The method of any of Aspects 1-3, wherein the one or more SD basis groups each include one or more sets of SD bases that are respectively associated with one or more TRPs included among the multiple TRPs.
Aspect 5: The method of any of Aspects 1-4, wherein the one or more SD bases selected for each respective SD basis group are each associated with a corresponding basis index.
Aspect 6: The method of Aspect 5, wherein the index that represents the one or more SD bases selected for each respective SD basis group is based at least in part on one or more combination coefficient values that map to the corresponding basis indexes associated with the one or more SD bases selected for the respective SD basis group.
Aspect 7: The method of any of Aspects 1-6, wherein the joint SD basis selection indicator encodes the index that represents the one or more SD bases selected for each of the one or more SD basis groups in accordance with a scaling factor.
Aspect 8: The method of Aspect 7, wherein the scaling factor has a value that is based at least in part on a quantity of the one or more SD bases that are selected for each of the one or more SD basis groups.
Aspect 9: The method of any of Aspects 1-6, wherein the joint SD basis selection indicator encodes the index that represents the one or more SD bases selected for each of the one or more SD basis groups in accordance with a vector.
Aspect 10: The method of Aspect 9, wherein each entry in the vector has a variable bit width that is based at least in part on a quantity of the one or more SD bases that are selected for each of the one or more SD basis groups.
Aspect 11: The method of any of Aspects 1-10, wherein the CSI includes information that indicates a quantity of the one or more SD bases that are selected for each of the one or more SD basis groups.
Aspect 12: A method of wireless communication performed by a network node, comprising: receiving, from a UE, CSI that includes a joint SD basis selection indicator for multiple TRPs; decoding, for each of one or more SD basis groups, a respective index that represents one or more SD bases selected for the respective SD basis group based at least in part on the joint SD basis selection indicator; and decoding, for each of the one or more SD basis groups, one or more SD basis indexes based at least in part on the respective index that represents the one or more SD bases selected for the respective SD basis group and an associated TRP index.
Aspect 13: The method of Aspect 12, wherein decoding the respective index that represents the one or more SD bases selected for each respective SD basis group is based at least in part on a total quantity of the multiple TRPs, one or more parameters that indicate a total quantity of SD bases per TRP, and a quantity of TRPs in each SD basis group.
Aspect 14: The method of any of Aspects 12-13, wherein the one or more SD basis groups each include a quantity of SD bases that satisfies a threshold.
Aspect 15: The method of any of Aspects 12-14, wherein the one or more SD basis groups each include one or more sets of SD bases that are respectively associated with one or more TRPs included among the multiple TRPs.
Aspect 16: The method of any of Aspects 12-15, wherein the joint SD basis selection indicator encodes one or more respective indexes that represent the one or more SD bases selected for each of the one or more SD basis groups in accordance with a scaling factor.
Aspect 17: The method of Aspect 16, wherein the scaling factor has a value that is based at least in part on a quantity of the one or more SD bases that are selected for each of the one or more SD basis groups.
Aspect 18: The method of any of Aspects 12-15, wherein the joint SD basis selection indicator encodes one or more respective indexes that represent the one or more SD bases selected for each of the one or more SD basis groups in accordance with a vector.
Aspect 19: The method of Aspect 18, wherein each entry in the vector has a variable bit width that is based at least in part on a quantity of the one or more SD bases that are selected for each of the one or more SD basis groups.
Aspect 20: The method of any of Aspects 12-19, wherein the CSI includes information that indicates a quantity of the one or more SD bases that are selected for each of the one or more SD basis groups.
Aspect 21: An apparatus for wireless communication at a device, comprising a processor; memory coupled with the processor; and instructions stored in the memory and executable by the processor to cause the apparatus to perform the method of one or more of Aspects 1-11.
Aspect 22: A device for wireless communication, comprising a memory and one or more processors coupled to the memory, the one or more processors configured to perform the method of one or more of Aspects 1-11.
Aspect 23: An apparatus for wireless communication, comprising at least one means for performing the method of one or more of Aspects 1-11.
Aspect 24: A non-transitory computer-readable medium storing code for wireless communication, the code comprising instructions executable by a processor to perform the method of one or more of Aspects 1-11.
Aspect 25: A non-transitory computer-readable medium storing a set of instructions for wireless communication, the set of instructions comprising one or more instructions that, when executed by one or more processors of a device, cause the device to perform the method of one or more of Aspects 1-11.
Aspect 26: An apparatus for wireless communication at a device, comprising a processor; memory coupled with the processor; and instructions stored in the memory and executable by the processor to cause the apparatus to perform the method of one or more of Aspects 12-20.
Aspect 27: A device for wireless communication, comprising a memory and one or more processors coupled to the memory, the one or more processors configured to perform the method of one or more of Aspects 12-20.
Aspect 28: An apparatus for wireless communication, comprising at least one means for performing the method of one or more of Aspects 12-20.
Aspect 29: A non-transitory computer-readable medium storing code for wireless communication, the code comprising instructions executable by a processor to perform the method of one or more of Aspects 12-20.
Aspect 30: A non-transitory computer-readable medium storing a set of instructions for wireless communication, the set of instructions comprising one or more instructions that, when executed by one or more processors of a device, cause the device to perform the method of one or more of Aspects 12-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor communicatively coupled with the at least one memory, the at least one processor configured to cause the UE to:
group a total quantity of spatial domain (SD) bases associated with multiple transmission reception points (TRPs) into one or more SD basis groups, each SD basis group including a set of SD bases;
select, for each respective SD basis group of the one or more SD basis groups, one or more SD bases from the respective set of SD bases included in the respective SD basis group;
identify, for each respective SD basis group of the one or more SD basis groups, an index that represents the one or more SD bases selected for the respective SD basis group; and
transmit, to a network node, channel state information (CSI) that includes a joint SD basis selection indicator for the multiple TRPs, the joint SD basis selection indicator indicating, for each respective SD basis group of the one or more SD basis groups, the respective index representing the one or more SD bases selected for the respective SD basis group.

2. The UE of claim 1, wherein the total quantity of SD bases associated with the multiple TRPs is based at least in part on a quantity of the multiple TRPs and one or more parameters that indicate a total quantity of SD bases per TRP.

3. The UE of claim 1, wherein the one or more SD basis groups each include a quantity of SD bases that satisfies a threshold.

4. The UE of claim 1, wherein the one or more SD basis groups each include one or more sets of SD bases that are respectively associated with one or more TRPs included among the multiple TRPs.

5. The UE of claim 1, wherein the one or more SD bases selected for each respective SD basis group are each associated with a corresponding basis index.

6. The UE of claim 5, wherein the index that represents the one or more SD bases selected for each respective SD basis group is based at least in part on one or more combination coefficient values that map to the corresponding basis indexes associated with the one or more SD bases selected for the respective SD basis group.

7. The UE of claim 1, wherein the joint SD basis selection indicator encodes the index that represents the one or more SD bases selected for each of the one or more SD basis groups in accordance with a scaling factor.

8. The UE of claim 7, wherein the scaling factor has a value that is based at least in part on a quantity of the one or more SD bases that are selected for each of the one or more SD basis groups.

9. The UE of claim 1, wherein the joint SD basis selection indicator encodes the index that represents the one or more SD bases selected for each of the one or more SD basis groups in accordance with a vector.

10. The UE of claim 9, wherein each entry in the vector has a variable bit width that is based at least in part on a quantity of the one or more SD bases that are selected for each of the one or more SD basis groups.

11. The UE of claim 1, wherein the CSI includes information that indicates a quantity of the one or more SD bases that are selected for each of the one or more SD basis groups.

12. A network node for wireless communication, comprising:
at least one memory; and
at least one processor communicatively coupled with the at least one memory, the at least one processor configured to cause the network node to:
receive, from a user equipment (UE), channel state information (CSI) that includes a joint spatial domain (SD) basis selection indicator for multiple transmission reception points (TRPs);
decode, for each of one or more SD basis groups, a respective index that represents one or more SD bases selected for the respective SD basis group based at least in part on the joint SD basis selection indicator; and
decode, for each of the one or more SD basis groups, one or more SD basis indexes based at least in part on the respective index that represents the one or more SD bases selected for the respective SD basis group and an associated TRP index.

13. The network node of claim 12, wherein the respective index that represents the one or more SD bases selected for each respective SD basis group is decoded based at least in part on a total quantity of the multiple TRPs, one or more parameters that indicate a total quantity of SD bases per TRP, and a quantity of TRPs in each SD basis group.

14. The network node of claim 12, wherein the one or more SD basis groups each include a quantity of SD bases that satisfies a threshold.

15. The network node of claim 12, wherein the one or more SD basis groups each include one or more sets of SD bases that are respectively associated with one or more TRPs included among the multiple TRPs.

16. The network node of claim 12, wherein the joint SD basis selection indicator encodes one or more respective indexes that represent the one or more SD bases selected for each of the one or more SD basis groups in accordance with a scaling factor.

17. The network node of claim 16, wherein the scaling factor has a value that is based at least in part on a quantity of the one or more SD bases that are selected for each of the one or more SD basis groups.

18. The network node of claim 12, wherein the joint SD basis selection indicator encodes one or more respective indexes that represent the one or more SD bases selected for each of the one or more SD basis groups in accordance with a vector.

19. The network node of claim 18, wherein each entry in the vector has a variable bit width that is based at least in part on a quantity of the one or more SD bases that are selected for each of the one or more SD basis groups.

20. The network node of claim 12, wherein the CSI includes information that indicates a quantity of the one or more SD bases that are selected for each of the one or more SD basis groups.

21-30. (canceled)
